(19) United States
(12) Patent Application Publication
(10) Pub. No.: US 2026/0006275 A1
(43) Pub. Date: Jan. 1, 2026

(54) PEER-TO-PEER COMMERCE SYSTEMS AND METHODS

(71) Applicant: Loupe Tech, Inc., Miami, FL (US)

(72) Inventors: Eric Doty, Miami, FL (US); Lee Moore, Canton, MI (US); Moneeb Sayed, Burlington, NC (US); Matthew Lock, Miami, FL (US)

(21) Appl. No.: 19/252,934

(22) Filed: Jun. 27, 2025

Related U.S. Application Data
(60) Provisional application No. 63/665,219, filed on Jun. 27, 2024.

(51) Int. Cl. H04N 21/254; G06Q 20/02; G06Q 30/0601; H04N 21/2187

(52) U.S. Cl. CPC H04N 21/2542; G06Q 20/02; G06Q 30/0613; H04N 21/2187

(57) ABSTRACT

An object of the present invention is to provide systems and methods for a peer-to-peer (P2P) livestream marketplace that allows users of a livestream hosting platform to purchase items showcased during a livestream and allows buyers to resell their purchased items to other users of the hosting platform. If a second buyer purchases the item from a first buyer, the item may then be shipped directly from the seller to the second buyer. A hosting platform service provider may operate the method of the invention via a service provider's servers that are in communication with seller and buyer client electronic devices. The hosting platform may charge fees for each transaction. Shipping costs may be paid by the second buyer to the seller via the hosting platform. The video livestream may be encrypted.

### CROSS-REFERENCE TO RELATED APPLICATIONS AND INCORPORATION BY REFERENCE

This U.S. Nonprovisional Patent application claims benefit of priority to U.S. Provisional Patent Application No. 63/665,219, entitled PEER-TO-PEER COMMERCE SYSTEMS AND METHODS, which was filed in the United States Patent and Trademark Office (USPTO) on Jun. 27, 2024, the entirety of which is hereby incorporated herein by reference.

### STATEMENT REGARDING FEDERALLY SPONSORED RESEARCH OR DEVELOPMENT

Not applicable.

### FIELD OF THE INVENTION

The invention described herein is in the field of livestream marketplaces. In particular, systems and methods are disclosed for a hosting platform which enables peer-to-peer (P2P) livestream marketplace(s) for users of the hosting platform to resell purchased items to other users of the hosting platform.

### BACKGROUND

In the realm of e-commerce, livestreaming has emerged as a revolutionary format for direct-to-consumer sales. Livestream marketplaces are online platforms where commercial entities, charitable organizations, and/or individuals broadcast (i.e. stream) live videos to viewers who can interact with a host (also referred herein as a “shop” or “seller”) and other viewers through comments and reactions in real-time. All viewers of a livestream are presented with opportunities to purchase products, items, and/or services which are showcased during the livestream. The integration of real-time (or near real-time) video streaming with interactive shopping can enhance consumer engagement and expedite the purchasing process.

However, in the state of the art, users currently lack the ability to resell purchased items directly through the same channel of their initial purchase. The lack of ability to resell purchased items drives potential revenue to third-party reselling platforms. This inability to resell purchased items directly through a livestream hosting platform decreases user engagement and loyalty.

In addition, the inability to resell items causes the operator of the platform to lose out on the lifecycle of a product's potential gross merchandise value (GMV). Gross merchandise value is a key metric commonly used in e-commerce and retail sectors to indicate the total sales volume of merchandise sold over a specific period of time through a particular platform or marketplace. Products that typically get sold many times throughout their life can generate substantial gross merchandise value for an e-commerce or retail operation if the series of repeated transactions are all brokered through the same platform, channel, or store.

For example, and not meant to be limiting, some typical product types that may be the subject of multiple transactions within their lifetime are sports cards, gaming cards, memorabilia electronic devices, automobiles, fashion and apparel, home appliances, furniture, sporting goods, and real estate.

In the case of livestream marketplaces, the opportunity to capture multiple transactions of the same product is enormous because the viewers of a livestream can be immediately identified as interested potential purchasers by virtue of the fact that they are watching the same livestream showcasing a particular type of product. In addition, the viewers of a livestream may also already be communicating amongst themselves about which products/items they are interested in purchasing. But, without the ability to resell a purchased item through the hosting platform, the would-be reseller would have to leave the livestream hosting platform and list the item for resale elsewhere.

Therefore, what is needed in the art, is a hosting platform of livestream showcases that provides for real time (or near real-time) peer-to-peer (P2P) reselling of items that are initially purchased during a livestream session, between the livestream viewers.

### SUMMARY

An object of the present invention is to provide systems and methods for a livestream hosting platform marketplace that allows users of the platform to purchase products showcased on a livestream and allows the same users/buyers to resell their purchased items to other viewers of the livestream.

In embodiments, the present invention is a hosting platform where sellers (commercial entities, charitable organizations, and/or individuals) may initiate a livestream showcase session wherein products or services may be listed for sale (and/or listed for resale) and purchased in real-time (or near real-time) by a user of the livestream hosting platform. In embodiments, the hosting platform has multiple livestreams occurring simultaneously. The hosting platform may present a list of livestreams to a user of the platform. The user can view the list of the livestreams that are occurring and select a particular livestream to join. While the user is in the joined livestream, users can purchase items that are listed for sale in real-time (or near real-time).

In an exemplary embodiment, the streaming, viewing, purchasing, and reselling of items are all managed through API requests made through the hosting platform's servers and third-party service providers. P2P reselling is enabled through utilization of the hosting platform's API servers and server push technology to send events to client devices, thereby triggering their actions in the P2P process.

In embodiments, any funds used by users of a hosting platform to purchase items from sellers are paid to the hosting platform.

In embodiments, any funds used by a second buyer to purchase a resale item from a first buyer are paid to the hosting platform.

A further object of the present invention is a method for providing a user who purchases a product during a livestream showcase to quickly resell the item during the livestream to a different viewer and quickly recoup all or a portion of the funds they used to originally purchase the item. For example, and not meant to be limiting, a method of the invention may comprise the following steps: 1) Seller A starts livestream A via a hosting platform using Seller A's client device; 2) a plurality of users of the hosting platform join livestream A on their respective client device(s); 3) a user purchases item X from Seller A during livestream A; 4) Seller A receives an indication that the purchaser of item X (a first buyer) may be open to reselling item X to another user (a second buyer) for Y amount; 5) Seller A creates a “resell” of item X from the first buyer to the second buyer for Y amount; 6) the first buyer receives a resell confirm/deny prompt for selection; 7) if the resell is confirmed by the first buyer, presenting the second buyer with a modal to complete the purchase of item X for Y amount; 8) upon the second buyer's acceptance to complete the purchase, acquiring the second buyer's shipping address information; 9) calculating any fees, taxes, and shipping costs to the second buyer to determine a total cost; 10) presenting the total cost to the second buyer and allowing them to complete the purchase; 11) after the purchase is completed, recording the transaction in a database and adding the payout credits to the first buyers wallet; 12) indicating, to Seller A and other all viewers of livestream A, that the transaction from the first buyer to second buyer was completed.

In embodiments, a method of the present invention may comprise a method for performing a peer-to-peer reselling of an item purchased through a livestream hosting platform, the method comprising the steps of:
initiating, by a seller, a first video livestream, wherein the first video livestream is initiated by the seller generating said first video livestream and communicating the first video livestream to a hosting platform operated by a service provider;
accessing and displaying, by a plurality of potential buyers, the first video livestream, each potential buyer of the plurality of potential buyers using a client device that is in data communication with said hosting platform to access and display the first video livestream;
offering, by the seller, to sell a first item, by displaying the first item as being for sale for a first purchase price in the first video livestream;
sending to the seller, by a first buyer, a request indicating first potential buyer's desire to purchase the first item, wherein in the first buyer is one of the potential buyers comprising the plurality of potential buyers;
purchasing the first item, by the first buyer, by transferring funds in the amount of the first purchase price to the hosting platform;
receiving, by the seller, an indication of the first buyer's desire to resell the first item for a second price;
notifying the remaining potential buyers of the plurality of potential buyers, by the hosting platform, that the first item is available for purchase from the first buyer, wherein the remaining potential buyers are defined as all the potential buyers comprising the plurality of potential buyers that are not the first buyer;
sending to the first buyer, by a second buyer, an indication of the second buyer's desire to buy the first item for a second purchase price, wherein the second buyer is one of the remaining potential buyers;
purchasing the first item, by the second buyer, by transferring funds in the amount of the second purchase price to the hosting platform;
notifying the seller, by the hosting platform, that the second buyer has completed a resell purchase of the first item;
delivering, by the seller, the first item to the second buyer.

In embodiments the first item may be one or more gaming cards or may be sports cards such as baseball cards, football cards, basketball cards, etc.

In embodiments the first item may be contained within a package or otherwise unbeknownst to users of the hosting platform that prevents the description of the first item from being known to the plurality of potential buyers prior to the purchase of the first item by the first buyer.

In embodiments, the method of the invention may further comprise the step of revealing the description of the first item to the remaining potential buyers after the purchase of the first item by the first buyer.

In embodiments, the step of revealing the description of the first item to the remaining potential buyers may be performed by the unpackaging of the first item on the first video livestream.

In embodiments, the method of the invention may further comprise the step of calculating shipping costs for shipping some of the items purchased from the seller to the first buyer, and adding the shipping costs to the first purchase price prior to payment of the first purchase price to the hosting platform by the first buyer.

In embodiments, the method of the invention may further comprise the step of calculating shipping costs for shipping the first item from the seller to the second buyer, and adding the shipping costs to the second purchase price prior to payment of the second purchase price to the hosting platform by the second buyer.

In embodiments, the method of the invention may further comprise the step of calculating sales tax due for sale of the first item from the seller to the first buyer, and paying, by the first buyer, the sales tax due for sale of the first item to the hosting platform.

In embodiments, the method of the invention may further comprise the step of calculating sales tax due for sale of the first item from the first buyer to the second buyer, and paying to the hosting platform, by the second buyer, the sales tax due for the resell of the first item to the first buyer.

In embodiments, each potential buyer of the plurality of potential buyers may deposit funds into at least one potential buyer-specific wallet or account held by the hosting platform, or controlled by the hosting platform, for the purpose of receiving, holding, and paying out funds for the purchase of the item, each potential buyer having at least one unique account.

In embodiments, the method of the invention may further comprise the step of withholding from the payment of the first purchase price by the first buyer, a transaction fee to be paid to the hosting platform.

In embodiments, the method of the invention may further comprise the step of withholding from the payment of the second purchase price by the second buyer, a transaction fee to be paid to the hosting platform.

In embodiments, the steps of payment of the first purchase price and the second purchase price may be carried out by transfer of funds in and/or out of the buyer accounts, or wallets, hosted on the hosting platform.

In embodiments, the steps of payment of the shipping costs may be carried out by transfer of funds in and/or out of the buyer accounts, or wallets.

In embodiments, the steps of payment of the first purchase price and the second purchase price may be carried out by transfer of funds in and/or out of the buyer accounts for the first buyer and the second buyer.

In embodiments, the steps of payment of sales tax may be carried out by transfer of funds out of the buyer account for the first buyer.

In embodiments, the steps of payment of sales tax may be carried out by transfer of funds in and/or out of the buyer accounts for the first buyer and the second buyer.

In embodiments, the first video livestream may be encrypted.

In embodiments, the hosting platform may be a static marketplace for the purchase of items. That is to say, items may be listed for sale on the hosting platform whereby one or more buyers can view item(s) for sale and purchase the item(s) from the seller when no livestream is occurring.

In embodiments, the features, functions, and elements of the invention described herein and depicted in the figures, and all legal equivalents thereof, may be present in any number or combination. Further, in embodiments, the invention may comprise a subset of the defined features and elements, in any combination. While a particular embodiment may comprise each of the features described and shown, it is not necessary that any other embodiment of the invention comprise each of the features described and shown.

The foregoing described steps and features are exemplary in nature and not intended to be limiting.

### BRIEF DESCRIPTION OF THE DRAWINGS

The accompanying drawings, which are incorporated into and form a part of the specification, illustrate one or more embodiments of the present invention and, together with the description, serve to explain the principles of the invention. The drawings are only for the purpose of illustrating exemplary embodiments of the invention and are not to be construed as limiting the invention. In the drawings:

FIGS. 1a-1b illustrate an exemplary embodiment of a system diagram of the invention.

FIGS. 2a-2d illustrate an abbreviated sequence of user interfaces that may be displayed on a client device.

FIG. 3 illustrates a simplified network diagram of a system of the present invention.

FIG. 4 illustrates an exemplary flowchart of a method of the present invention.

FIG. 5 is an embodiment of a user interface displayed on a screen of a client device showing a first buyer and second buyer negotiating a deal for resale of an initially purchased item.

FIG. 6 is an embodiment of a user interface with alphanumeric fields for inputting resell information displayed on a screen of a seller's client device showing creation of a “resale”.

FIG. 7 is an embodiment of a user interface displayed on a screen of a first buyer's client device.

FIG. 8 is an embodiment of a user interface displayed on a screen of a first buyer's client device.

FIG. 9 is an embodiment of a user interface displayed on a screen of a first buyer's client device.

FIG. 10 is an embodiment of a user interface displayed on a screen of a user's client device.

FIG. 11 is an embodiment of a user interface displayed on a screen of a second buyer's client device.

FIG. 12 is an embodiment of a payment user interface displayed on a screen of a second buyer's client device.

FIG. 13 is an embodiment of a user interface displayed on a screen of a second buyer's client device.

FIG. 14 is an embodiment of a user interface displayed on a screen of a user's client device.

FIG. 15 is an embodiment of a user interface displayed on a screen of a user's client device.

FIG. 16 is an embodiment of a user interface displayed on a screen of a user's client device.

### DETAILED DESCRIPTION

The following documentation provides a detailed description of the invention.

Although a detailed description as provided in this application contains many specifics for the purposes of illustration, one of ordinary skill in the art will appreciate that many variations and alterations to the following details are within the scope of the invention. Accordingly, the following preferred embodiments of the invention are set forth without any loss of generality to, and without imposing limitations upon, the claimed invention. Thus, the scope of the invention should be determined by the appended claims and their legal equivalents, and not merely by the preferred examples or embodiments given.

As used herein, “computer” and “server” which may be used interchangeably, mean systems and devices that, alone or in combination, are operable to process and execute non-transitory computer readable and executable instructions. These computer readable and executable instructions typically reside in, or are stored on, non-transitory computer readable media that is in data communication with one or more microprocessors, firmware or controllers, such that the microprocessors, firmware or controllers are able to read and to execute such non-transitory computer readable and executable instructions. Such a medium may take many forms, including, but not limited to, non-volatile media and volatile media. The computer (or server) may comprise one or more microprocessors, firmware or controllers, such that the microprocessors may also be able write information to a non-transitory computer readable medium (or media), which may be, but is not necessarily, the same non-transitory computer readable media upon which is stored the non-transitory computer readable and executable instructions. The non-transitory computer readable media (or memory) may be any type of physical media, such as, for example and not by way of limitation, solid state memory, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read. The microprocessors, firmware or controllers of the computer or server may also be in data communication with one or more transceivers, which may be operable to communicate data via wired or wireless data connections to one or more external or remote systems or data communication terminals. Wireless communication includes within its meaning both RF and optical wireless communication. Further, in a computer or server, the microprocessors, firmware or controllers may also be in data communication with one or more physical displays, such as smartphone displays, computer monitors or even television displays, and with mouse pads, keyboards. Thus, the computer is able to read and execute non-transitory computer readable and executable instructions that is stored in non-transitory computer readable media, and, by executing such non-transitory computer readable and executable instructions, carry out the functions and method steps of the invention.

As used herein, a “client device” means any electronic device capable of receiving, storing, processing, and/or sending data in a network environment, whether it is operated by a human user or automated systems. Client device may also herein be referred to as a “user device” or “mobile device.” The term encompasses a broad range of embodiments, characterized by their capabilities to connect to a server or peer devices, directly or indirectly, to access, utilize, or contribute to services, resources, or data available on a network. Some following non-limiting examples may include portable devices such as smartphones, tablets, laptops, handheld gaming consoles, and wearable devise; stationary devices such as desktop computers, kiosks, stationary terminals, and embedded systems that are typically fixed in a location; vehicle-mounted devices integrated into vehicles, including cars, trucks, bicycles, and public transportation vehicles, which also may serve navigation, communication, and/or entertainment functions. Client devices are capable of connecting to a network via wired (Ethernet, USB, HDMI, etc.,) or wireless (Wi-Fi, Bluetooth, NFC, cellular networks, technologies and are able to function as a standalone device or in a connected environment, including local area networks (LAN) and wide area networks (WAN), the internet, or intranets.

A client device may utilize one or more local data stores, which may be internal or external devices, and may include one or more of a short-term memory (e.g., random access memory), a cache, a drive (e.g., a hard drive), a flash drive, a database system, or another type of component or device capable of storing data. The local data stores may also include multiple storage components (e.g., multiple drives or multiple databases) that may also span multiple computing devices (e.g., multiple server computers). In some embodiments, the local data stores may be used for data back-up or archival purposes.

A client device may implement a user interface for allowing the client device to send/receive information to/from other client devices. The user interface may be a graphical user interface (GUI). For example, the user interface may be a web browser interface that can access, retrieve, present, and/or navigate content (e.g., web pages such as Hyper Text Markup Language (HTML) pages) provided by the hosting platform's server(s). In an exemplary embodiment, the user interface may be a standalone application (e.g., a mobile application), that enables a user to use the client device to send/receive information to/from other user devices and the hosting platform's server(s).

As used herein, a “network” and “data network” includes within its meaning any public network (e.g., the Internet), any private network (e.g., a local area network (LAN) or wide area network (WAN)), any wired network (e.g., Ethernet network), any wireless network (e.g., an 802.11 network or a Wi-Fi network), any cellular network, routers, hubs, switches, servers, computers, and/or any combination thereof. Although reference will be made to a single network throughout this disclosure, the embodiments described herein may include one or more networks operating as stand-alone networks or in co-operation with each other.

As used herein, a “user” means any individual or entity who accesses the hosting platform. A user may be a seller, first buyer, viewer, and/or second buyer.

As used herein, a “shop” or “seller” means any individual or commercial entity which uses the hosting platform described herein to initiate an interactive livestream for showcasing items or services for sale to one or more viewers of the livestream. The seller may also initiate and/or facilitate the reselling of purchased items between users of the hosting platform.

As used herein, a “hosting platform” means an application or website which provides a shop or seller with the ability to broadcast livestreams in real-time (or near real-time) to one or more other user(s) of the hosting platform.

As used herein, a “first buyer” or “reseller” means any user of a hosting platform who wishes to resell an item he/she/they purchased during a livestream showcase to another user of the hosting platform.

As used herein, a “second buyer” means any user of the hosting platform who wishes to purchase an item for resale from a first buyer/reseller during a livestream showcase.

The systems and methods of the invention may comprise multiple livestreams where sellers stream live video and list items for sale. Users of a hosting platform can join and view livestreams. While in a livestream, users can purchase items that have been listed for sale or resale.

The streaming, viewing, purchasing, and reselling of items are all managed through API requests made to a hosting platform's servers and third-party service providers. P2P reselling as described herein utilizes API servers and server push technology to send events to client devices triggering their actions in the P2P process.

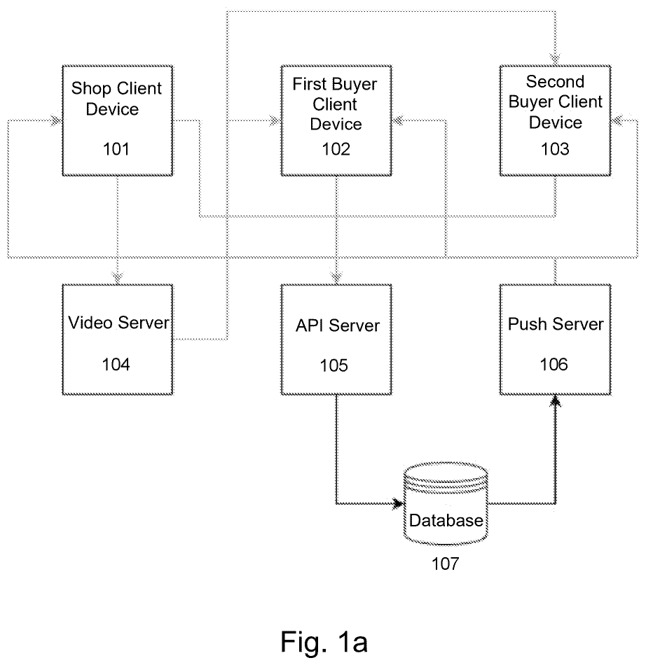

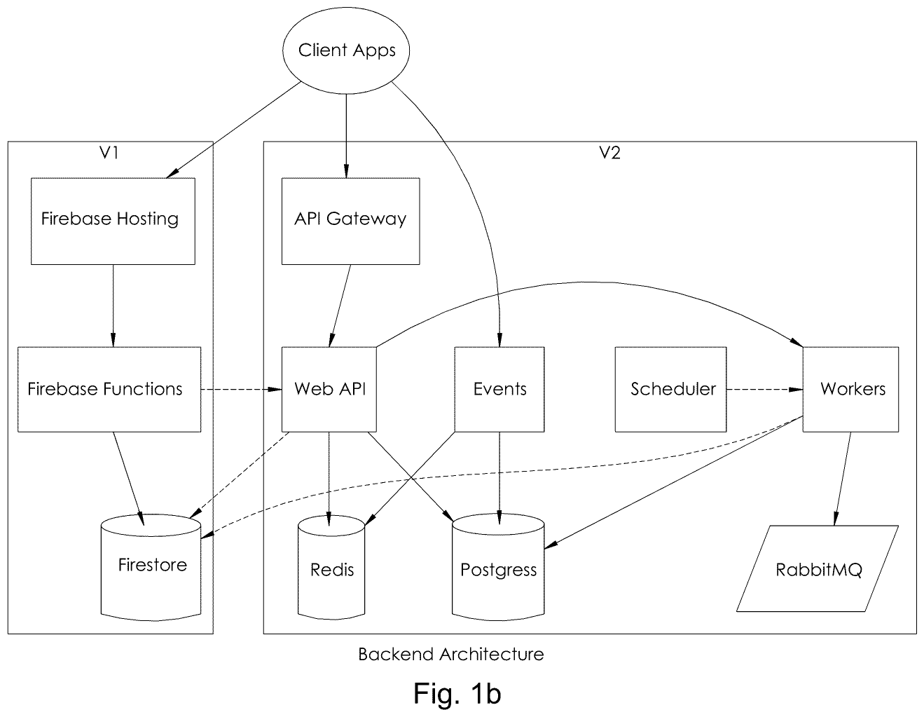

Referring to FIG. 1a, an exemplary embodiment of a system diagram of the invention is shown. A system of the present invention may comprise a shop/seller client device 101, a first user client device 102, a second user client device 103, a video server 104, an API server 105, a push server 106, and a database 107. The video server 104, API server 105, push server 106, and database 107 may be accessible via a data network and may be operated by a third-party service provider that manages and operates the server(s) and database(s). The devices of the system are merely illustrative, and it is to be understood that additional shop devices, client devices, servers, networks, databases, and data storage devices may be present and would be understood by a person of ordinary skill in the art as being included within the scope of this disclosure.

A video server 104 is a server that may be operable to receive video and audio streams from a seller client device and multiplex the video and audio to multiple receiving user client devices. A video server 104 may be a low-latency streaming server or it may be a real-time (or near real-time) streaming server. For example, and not meant to be limiting, the video server 104 may be implemented using Amazon Interactive Video Service (IVS) Low-Latency Streaming as a third-party video streaming service. In other embodiments, the video server may be implemented using any other low-latency or near real-time live-video streaming service that is now known in the art or that may become known in the art.

A database 107 of a system of the present invention may be a local database or it may be a cloud-based database. For example, and not meant to be limiting, a database 107 may be implemented using persistent databases such as Amazon RDS Postgres and/or Cloud Firestore. In addition, the hosting platform may further utilize AWS Elasticache for caching in order to improve the overall performance of the system and reduce latency. Similar to the API servers described herein, these persistent databases may be considered a single unit giving the overlap in utilization between the two.

A push server 106 functions to provide real-time (or near real-time) updates/events/prompts/notifications/modals from backend servers. These include but are not limited to polling, websockets, and server sent events. These real-time (or near real-time) updates are critical to triggering each stage of the P2P sale flow. For example and not meant to be limiting, the hosting platform may utilize Cloud Firestore Realtime Updates as a mechanism for clients to receive updates as users enter/exit streams and as showcased items move through the resale flow.

Referring now to FIG. 1b, in embodiments, the backend architecture may comprise a V1 API server using Cloud Functions for Firebase which consists of a series of RPC endpoints which run on a serverless compute platform. The functions use the Node.js runtime and functions are implemented using a combination of Javascript and Typescript which is compiled into a unified Javascript target for execution.

In embodiments, the backend architecture may comprise a V2 API server utilizing Amazon Web Services (AWS). Implementation of V2 through AWS may utilize services such as AWS Fargate and AWS API Gateway. This API server has a combination of REST and RPC endpoints. The software architectural pattern of this server is a multi-tiered monolith. This API server is implemented in Golang and runs on the Buffalo web API framework. Although utilizing separate infrastructure, these API servers may be viewed as a unified server since there is substantial overlap. Purchases made through the hosting platform may utilize any third-party payment processor. For example, and not meant to be limiting, the third-party payment processor may be Stripe.

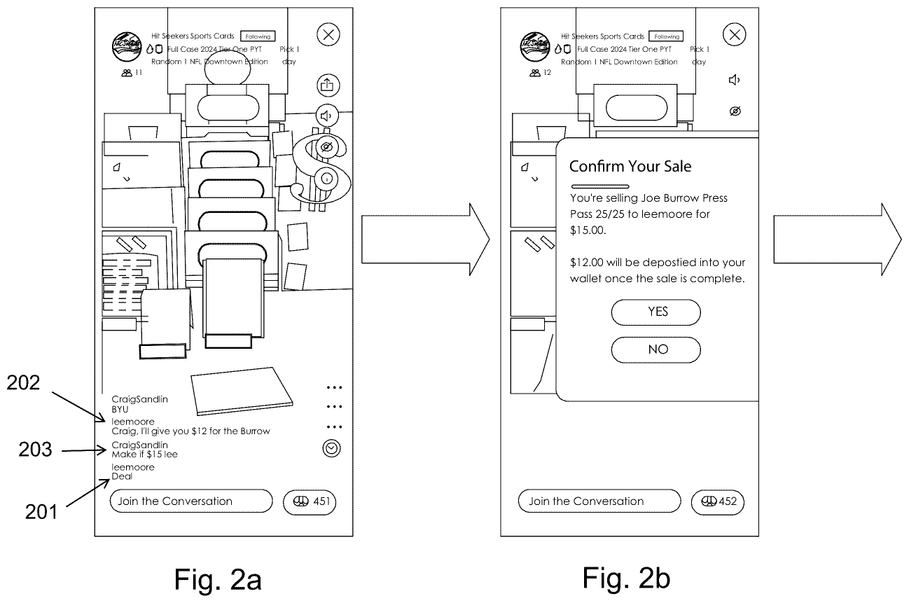

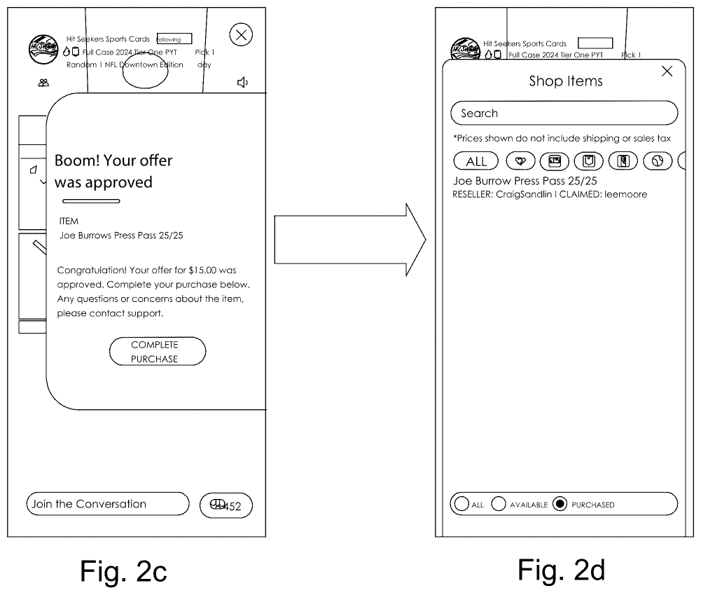

Referring to FIGS. 2a-2d, an illustration showing an abbreviated sequence of user interfaces that may be displayed on client device(s). Generally, a deal is made 201 when a second buyer 202 strikes a deal with a first buyer 203 for the resale of an item initially purchased during the livestream by the first buyer. FIG. 2b shows a user interface that may be presented to the first buyer 203 to confirm the resale. FIG. 2c shows a user interface that may be presented to the second buyer 202 indicating an acceptance of the resale. FIG. 2d shows user interfaces which provide users of the hosting platform an intuitive way to filter and/or navigate items available for sale and items purchased on the livestream.

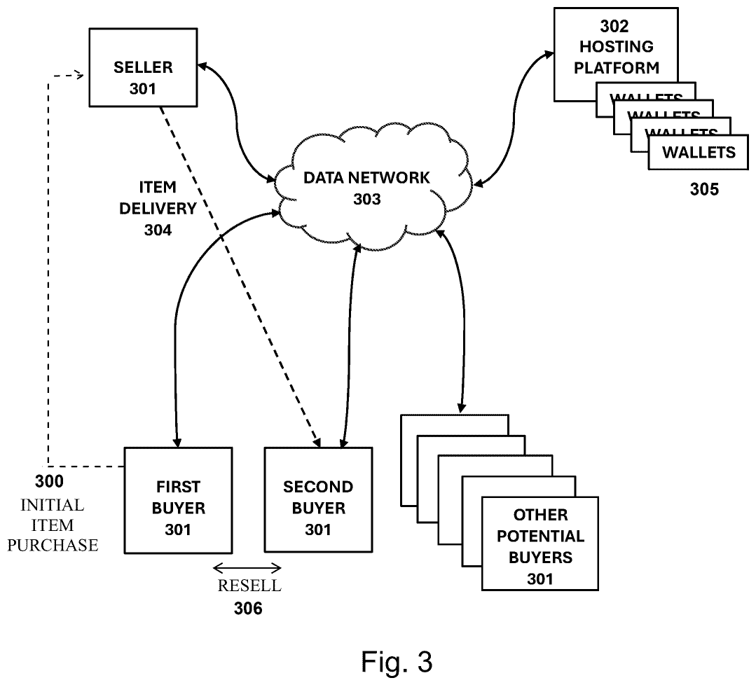

Referring to FIG. 3, a simplified network diagram of a system of the present invention is shown. The system includes one or more client device(s) 301, which may be for example seller client devices and/or buyer client devices, a hosting platform 302 comprising one or more servers, with each device of the system being communicatively coupled via a data network 303.

Although each of the client devices 301, and the server(s) 302 are depicted in FIG. 3 as single, separate components, these components may be implemented together in a single device or networked in various combinations of multiple different devices that operate together. In some embodiments, some or all of the functionality of the server(s) 302 may be performed by the client devices 301, or other devices that are under control of the hosting platform's server(s).

In embodiments, the method generally begins when a first buyer makes an initial purchase 300 of an item being showcased by the seller in a livestream. After the “unboxing” or “breaking” of the item from its packaging to reveal what the item is, the first buyer and a second buyer may participate in a P2P “resell” 306 of the initially purchased item.

Once the second buyer has purchased the resale item (i.e. initially purchased item) by payment of the second purchase price, the item is delivered 304 by the seller to the second buyer. The method of delivery may be any method of delivery such as shipping by ground, rail, maritime, air carrier, or any combination of the foregoing.

Each user of the hosting platform may have one or more user or buyer-specific unique virtual “wallet” (or “account”) 305 per user or buyer which have funds or credits deposited therein by a user or buyer to create an amount balance greater than or equal to $0.00. Wallet (account) balances may be applied to purchases, pursuant to the method steps described herein, such that buyer or user payments may be made for purchases of items. Any purchase made by users of the hosting platform is paid directly to the hosting platform. The user (buyer) accounts and payments may be made and/or managed using a third-party payment processor.

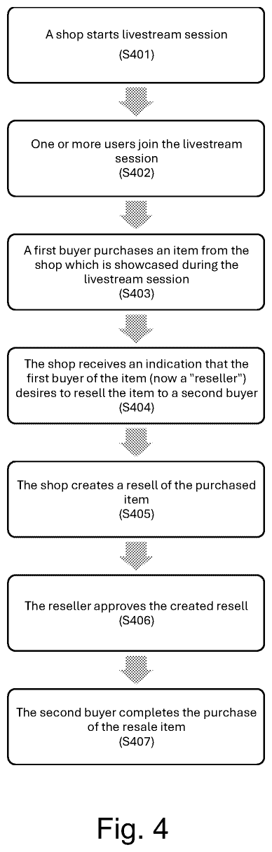

Referring to FIG. 4, a flowchart of an exemplary embodiment of a method of the present invention is shown. The streaming, viewing, purchasing, and reselling of items through the hosting platform may all be managed through API requests made to one or more hosting platform server(s) and third-party service providers. The method described herein utilizes the hosting platform's API server(s) and server push technology to send events/notifications/prompts/modals to client devices requiring action in the P2P resell process.

In step S401, a seller (e.g. an individual, commercial entity, and/or a charitable organization) starts a livestream showcase on the hosting platform using a seller client device. This may be accomplished by the seller's client device 101 sending a request to the hosting platform's API server(s) to start a livestream showcase. In embodiments, the API call may be HTTP Method: POST; API Path:/v2/streams; Request Body: stream title, stream image.

The seller is then able to livestream video directly from their client device 101 to the video server 104 which is then viewable in real-time (or near real-time) by other users of the hosting platform. In embodiments, the Video may be streamed using RTMPS protocol. This protocol is used to securely send encrypted packets containing video and audio data to the video server 104. Once these packets reach the server, they are decrypted to be sent using HLS to clients that are connected to this video stream. Video packets are sent persistently to the video server 104 until the seller decides to end the livestream which results in sending a REST API request to the API Server.

Users of the hosting platform may log-in to or otherwise access the hosting platform to view a list of current livestreams that are available to be joined. In some embodiments, the viewable livestreams may be presented as icons (or any other suitable manner) instead of a list. In step S402, one or more other users of the hosting platform (e.g. buyers) may navigate the hosting platform user interface and select a livestream showcase to join. Upon selection of a livestream showcase, the video is received by the user's client device using HLS protocol. The video server 104 sends video segments that make up the HLS protocol. These video segments are sent over a series of network packets to the receiving clients. An API call is sent to the hosting platform's API server(s) indicating that the user(s) is viewing the livestream. In an embodiment, the API call may be HTTP Method: PUT; API Path:/v2/streams/{id}/audience; Request Body: user id. As a result of the API call, the user's username may now be seen on a display screen of the respective client devices of the seller and any other users who are also currently viewing the same livestream showcase.

In step S403, one or more users of the hosting platform may purchase an item from a seller that is listed or showcased for sale in the currently joined livestream session. A user who purchases an item listed for sale from a seller during a livestream session may herein be called a “first buyer” or “reseller”. The item purchased by the first buyer may herein be called an “initial purchase”, “initially purchased item”, “first purchase”, etc.

In step S404, the first buyer may receive a private message or a message in a chat from another user of the livestream (hereinafter a “second buyer”) indicating a desire to buy the purchased item from the first buyer. In embodiments, the first buyer may send a message to the seller (via private message or chat message) indicating a desire to resell the purchased item to a second buyer. In other embodiments, the seller may be monitoring the chat and proactively initiate a resell of the purchase item to a second buyer. Still in further embodiments, the seller or the first buyer may initiate a live auction using the chat for the purchased item.

In any case, the seller creates a peer-to-peer (P2P) “resell” of the purchased item from a first buyer to a second buyer at step S405. The seller may pull up the viewer list on the user interface of their client device showing all the current viewers of the livestream. The seller may navigate the user interface and select a first buyer from the viewer list. Upon selection of the first buyer, the seller is presented an option in the audience controls menu to Create Resale Item. Upon selection of the Create Resale Item, the seller is directed to input resell information for creation of the resale item in a creation modal. The creation modal may require the seller to indicate the first buyer/reseller, the item description, the resell amount, and the second buyer. After the seller inputs the required information in the creation modal, the seller can then submit the creation of the resale item. In embodiments, submission of the creation modal sends a request to an API server using HTTP Method: POST; API Path:/v2/items; Request Body: item name, price, category, reseller, buyer

Once the seller submits the created resale item on their client device, the hosting platform's push server transmits a Resell Created Confirmation Modal to the reseller's client device. The Confirmation Modal displays information input by the seller in step S405 and also presents a confirm/deny prompt on the reseller's client device. One of ordinary skill would appreciate that there are many embodiments within the scope of a confirm/deny prompt, for example and not meant to be limiting, “approve”, “sell”, “confirm”, “cancel”, “deny”, “exit”, “go back” or any combination of the foregoing may be presented to the reseller. In an embodiment, the Confirmation Modal may display the one or more of the following: Headline-YOUR RESALE WAS CREATED; ITEM-Item Info; Second Buyer-Buyer Username; SALE DETAILS-PRICE. $XXXX.XX, PROCESSING FEE . . . $XXXX.XX (price x % fee), TOTAL EARNED $XXXX.XX (price-% fee); and Terms and Conditions.

If the reseller is selling an item for the first time, a check box should be unmarked until the reseller has clicked and read the terms and conditions of service of the resell and has clicked “I understand” in the modal. The checkbox should not be clickable if the user has not clicked and read the terms and conditions and clicked “I understand” inside the slide up modal.

Once the reseller has confirmed “I understand”-mark the check box within the confirmation modal. Any subsequent resells by the reseller will result in the checkbox being hidden and the “Sell Item” button should be active. Once the checkbox has been marked, the reseller can click “Sell Item.”

If the reseller denies the resale, the process is terminated and the seller is presented with a modal showing that the resale was canceled.

If the reseller confirms the resale, the reseller's client device will send an API request to the API server(s) indicating the approval, step S406. In embodiments, the reseller client device sends a request to the API server to approve the resell of the item using HTTP Method: POST; API Path:/v2/items/{id}/reseller-approve; Request Body: approve (true or false).

In turn, the hosting platform's server(s) will push a purchase notification/modal for display on the second buyer's client device. The purchase notification/modal displaying purchase information to the second buyer. In an exemplary embodiment, the purchase information may comprise some or all of the following: a headline, a body, item description, reseller username, resell amount, any fees, any credits used, shipping costs, tax information, a total amount due from the second buyer, and/or a purchase section.

In non-limiting embodiments, the headline may display an indication to the second buyer that they may now complete the purchase of the resell item. For example, the headline may state “SCORE! Your offer was approved” or in other embodiments the headline may state “Complete Your Purchase”. The body may contain any relevant message or transaction information indicating that the second buyer may complete the purchase of the resell item. The purchase section may allow the second buyer to complete the transaction using Apple Pay, Google Pay, Samsung Pay, Credit Card, Debit Card, and/or credits.

In step S407, the second buyer completes the purchase of the resell item from the first buyer. In embodiments, the second buyer client device sends a request to the API server to approve the resell of the item using HTTP Method: POST; API Path:/v1/purchaseIntent; Body: item id, purchasing user id.

Upon completing the resale, the net funds resulting from the sale will be deposited into the reseller's wallet on the hosting platform; the chat will be notified; and the seller will be notified. The seller, first buyer/reseller, and second buyer will automatically receive an email confirmation regarding the details of the completed resale purchase. Once the second buyer has completed the transaction, the seller will then ship the purchased/resell item directly to the second buyer.

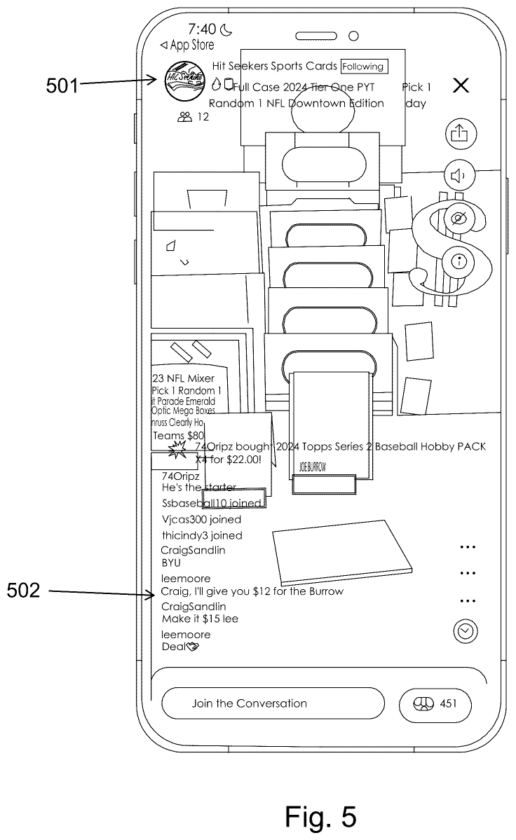

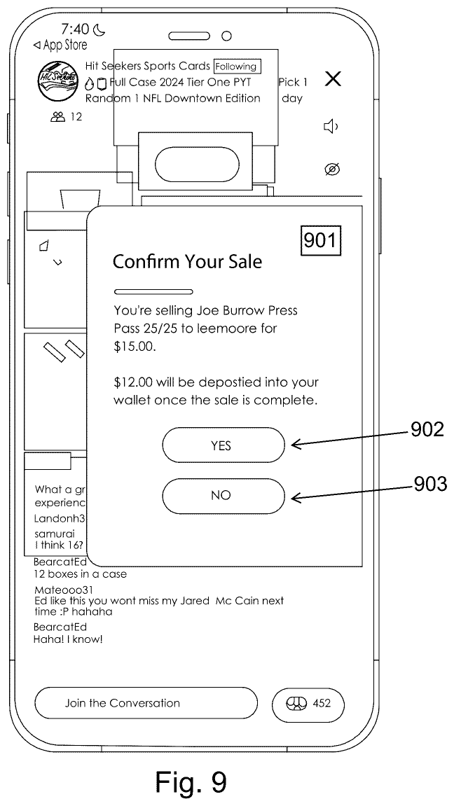

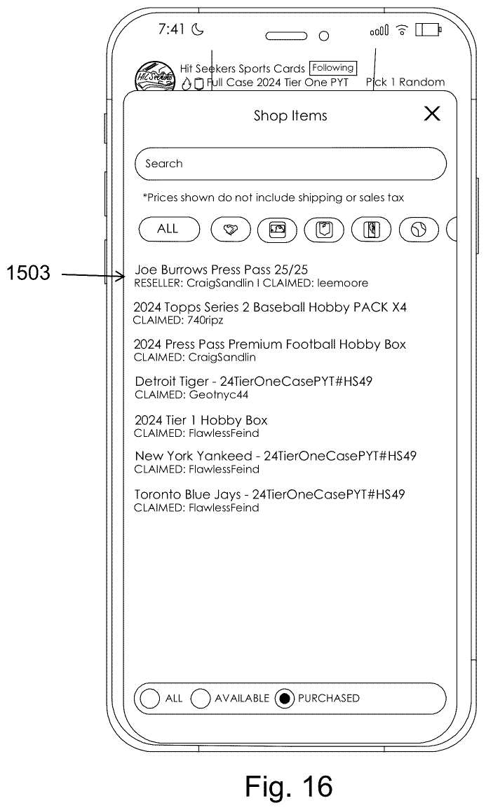

Referring to FIGS. 5-16, these figures illustrate exemplary embodiments of user interfaces that may be presented and displayed on client devices. However, the specific user interfaces depicted in the figures are provided for illustrative purposes only and are not intended to limit the scope of the present invention. A person of ordinary skill in the art will understand that the invention may be practiced using fewer or additional user interfaces than those specifically shown in the figures, and that variations in the design, layout, and functionality of such interfaces fall within the contemplated scope of this disclosure.

Furthermore, a person of ordinary skill in the art will recognize that the sequence or order in which the user interface screenshots are presented in the figures may be rearranged, modified, or adapted to suit particular implementation requirements without departing from the spirit and scope of the invention. Additionally, it will be understood that one or more of the illustrated user interfaces may be simultaneously transmitted to, displayed on, or otherwise presented across multiple different client devices, whether such devices are of the same type or different types, and whether operated by the same user or different users of the hosting platform.

Referencing FIG. 5, a shop 501 has started a livestream showcase displaying potential items for purchase. The users/buyers who are viewing the livestream showcase are able to watch the showcase and chat with other users who are also watching the livestream 502. As can be seen in 502, a first buyer has engaged in a chat conversation with a second buyer regarding making a resell of the item purchased by the first buyer. In this case, the second buyer proposed to purchase a Joe Burrow card from the first buyer.

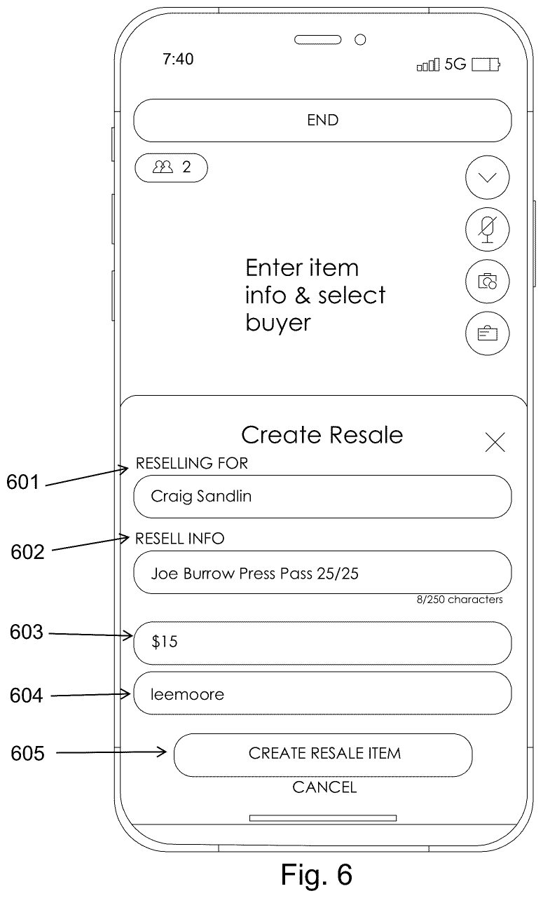

Referring to step S405, wherein the seller creates a peer-to-peer (P2P) “resell” of the purchased item from the first buyer to a second buyer at step. As can be seen in FIG. 6, the seller is presented an option in the audience controls menu to Create Resale Item. Upon selection of the Create Resale Item, the seller is directed to input resell information for creation of the resale item in a creation modal. The creation modal may require the seller to indicate the first buyer/reseller 601, the item description 602, the resell amount 603, and the second buyer 604. After the seller inputs the required information in the creation modal, the seller can then submit the creation of the resale item by selecting the appropriate button 605.

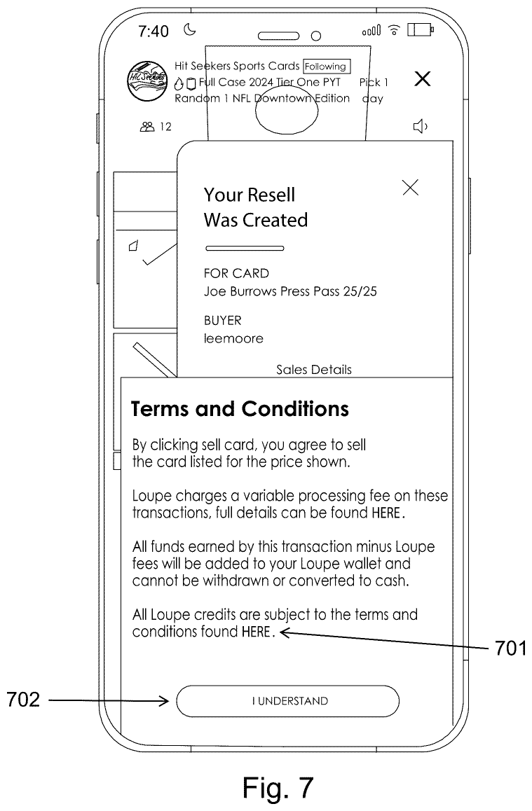

Once the seller submits the created resale item on their client device, the hosting platform's push server transmits a Resell Created Confirmation Modal to the reseller's client device, as can be seen in FIG. 7. If the reseller is selling an item for the first time, the reseller is not allowed to proceed with the resale until the reseller has clicked and read the terms and conditions of service 701 of the resell and has clicked “I UNDERSTAND” in the modal 702. The “I UNDERSTAND” button is not clickable until the user has clicked and read the terms and conditions 701.

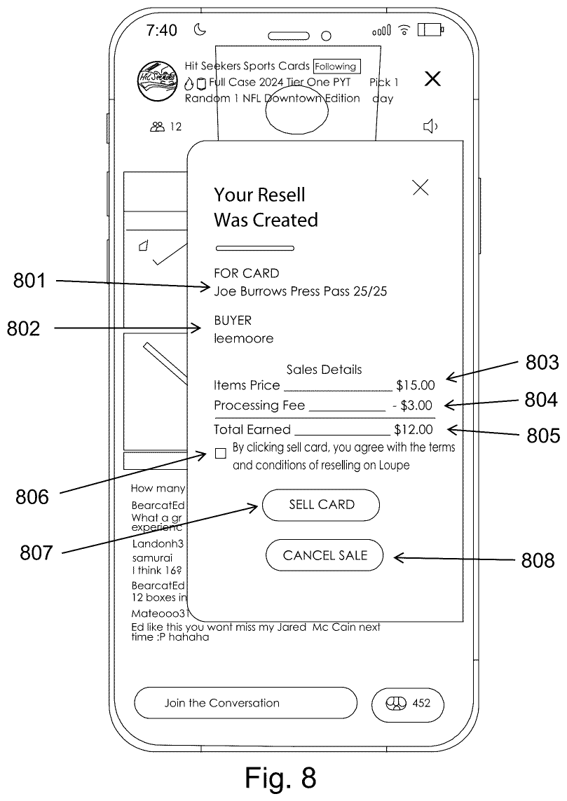

Once the reseller has confirmed “I UNDERSTAND”, the reseller is presented with the user interface shown in FIG. 8., whereby the reseller can see the item description 801, the second buyer's information 802, the price for the item 803, the processing fee 804, the total that will be earned by the reseller 805. The reseller can now complete the resale by clicking checkbox 806 and agreeing to the resale 807. Alternatively, if the reseller denies the resale by clicking “Cancel Sale” 808, the process is terminated and the seller is presented with a modal showing that the resale was canceled.

Upon agreeing to the terms of the resale by selection of 807, the reseller is presented with a Confirmation Modal 901 prompt on the reseller's client device to review and confirm 902 or deny 903 the terms of the resale.

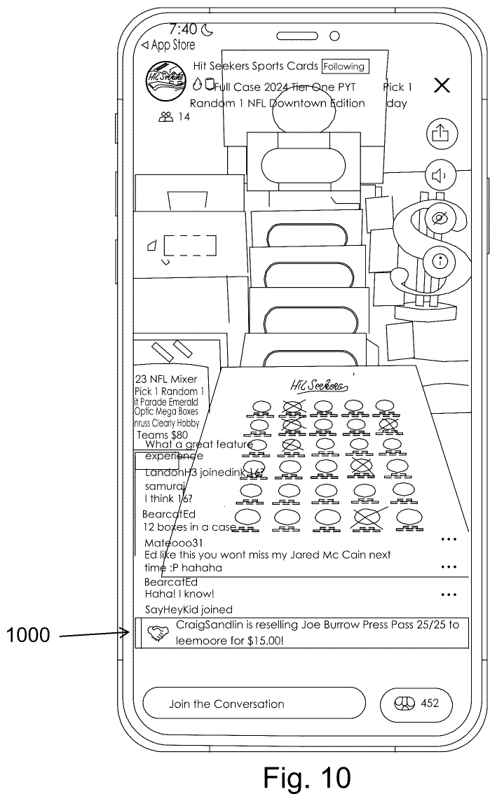

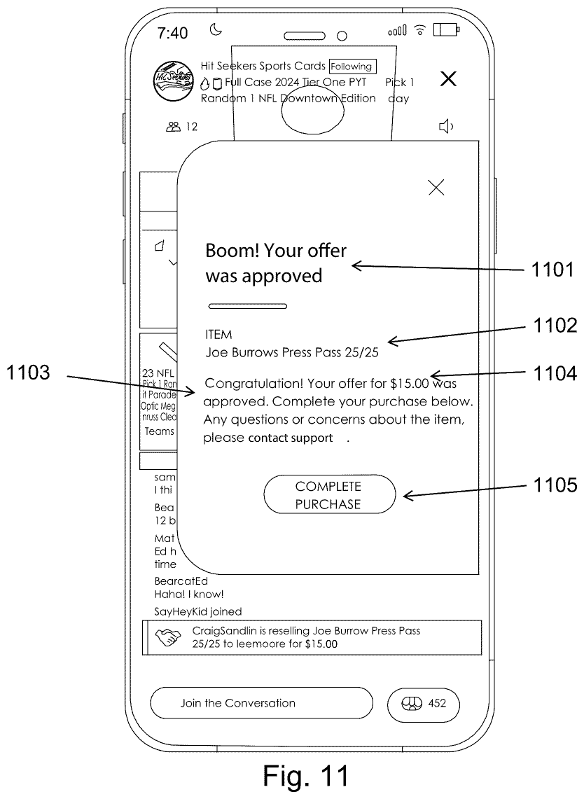

Upon confirmation by reseller 902, 1) the other users viewing the livestream are notified of the resale by a pop-up message 1000 in the chat, as shown in FIG. 10; and 2) a purchase notification/modal will be pushed for display on the second buyer's client device, as shown in FIG. 11. The pop-up message 1000 provides information of the resale to the other users on the hosting platform. For example, and not mean to be limiting, the pop-up message 1000 may provide identification of the first buyer, item description, purchase price, and/or the second buyer.

Referring to FIG. 11, the purchase notification/modal displaying purchase information to the second buyer. In an exemplary embodiment, the purchase information may comprise some or all of the following: a headline 1101, item description 1102, a body 1103, reseller username (not shown), resell amount 1104, any fees (not shown), any credits used (not shown), shipping costs (not shown), tax information (not shown), a total amount due from the second buyer (not shown), and/or a complete purchase section 1105.

In non-limiting embodiments, the headline may display an indication to the second buyer that they may now complete the purchase of the resell item. For example, the headline may state “BOOM! Your offer was approved” or in other embodiments the headline may state “Complete Your Purchase”. The body 1103 may contain any relevant message or transaction information indicating transaction information and that the second buyer may now complete the purchase of the resell item. The purchase section 1105 may allow the second buyer to complete the transaction using Apple Pay, Google Pay, Samsung Pay, Credit Card, Debit Card, and/or credits.

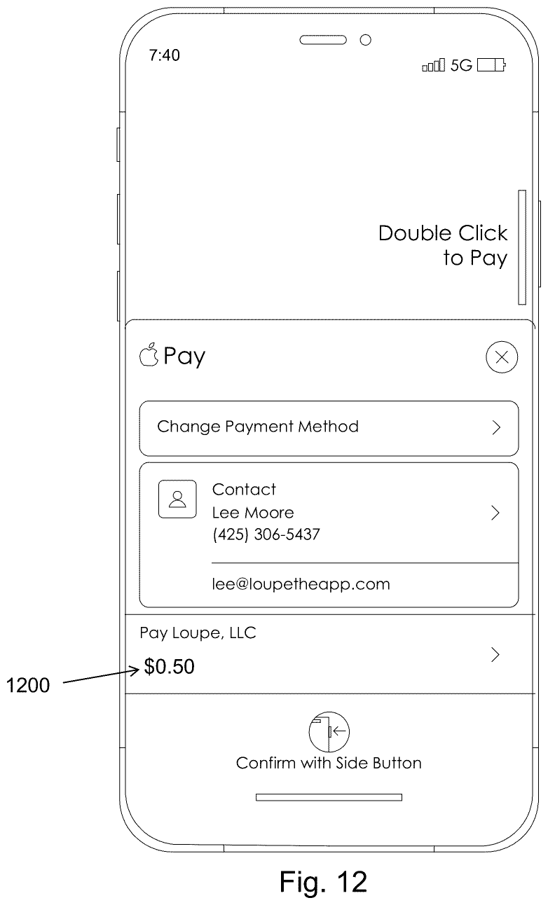

Completing the purchase 1105 allows the second buyer to complete the transaction using Apple Pay as shown in FIG. 12. Payment transactions completed through the hosting platform may utilize any of a variety of payment methods and processing systems, including but not limited to Apple Pay, Google Pay, Samsung Pay, traditional credit card processing, debit card processing, or any other payment method now known in the art or that may become known in the art in the future. The integration and implementation of third-party payment processing platforms and services is conventional and well-established in the art, and the specific technical details of such payment processing systems need not be disclosed herein for enablement purposes. A person of ordinary skill in the art would readily understand how to integrate and configure appropriate payment processing capabilities with the hosting platform to facilitate secure transaction processing using any desired payment method or combination of payment methods, whether currently available or developed subsequent to the filing of this application.

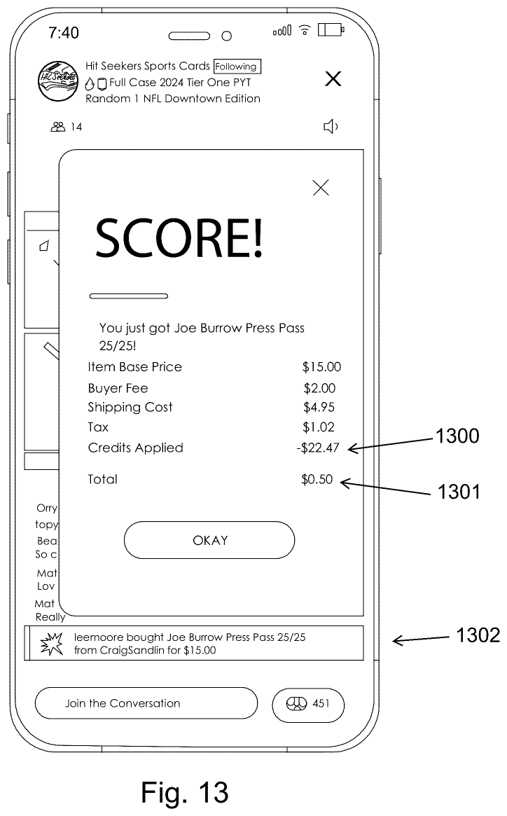

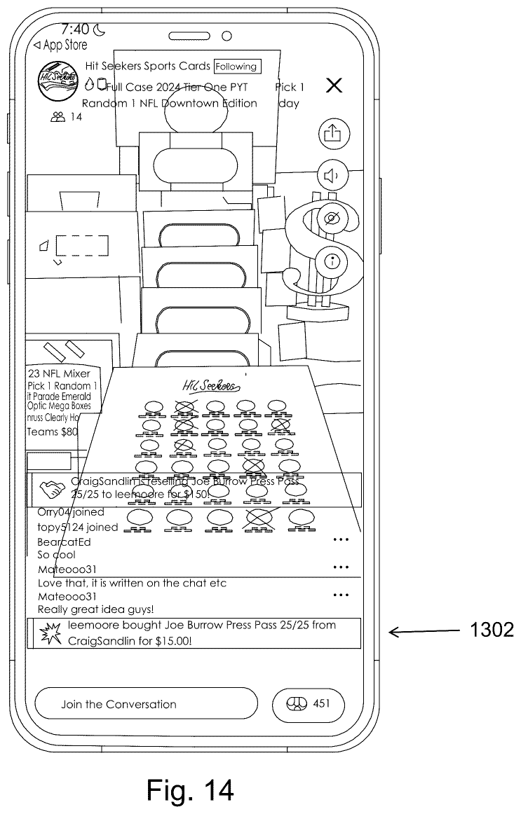

Referencing FIG. 13, in this embodiment the second buyer may be presented with an itemized invoice/receipt after completing the payment (FIG. 12). The fees, costs, taxes, credits, etc., shown in FIG. 13 are only exemplary in nature. A person of ordinary skill in the art would readily understand that more or less information may be presented to the second buyer either before or after completing the purchase. As can be seen, the second buyer applied $22.47 of credit 1300 from their wallet leaving only a balance of $0.50 1200, 1301 to complete the transaction. A “completed deal” pop-up message 1302 is simultaneously presented in the chat notifying the other viewers of the livestream that the deal is completed (also seen in FIG. 14).

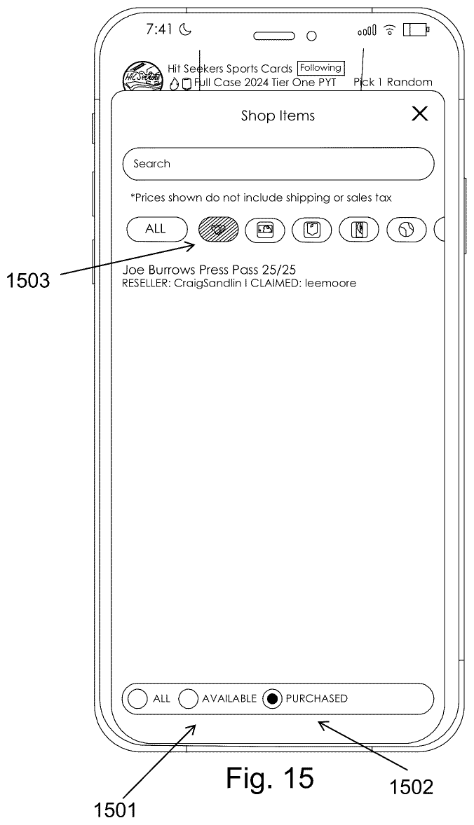

Referring to FIGS. 15 & 16, user interfaces are shown which provide users of the hosting platform an intuitive way to filter and/or navigate available items for purchase 1501, already purchased items 1502, items which have gone through a resale 1503, etc.

The above-described systems and processes improves upon conventional purchasing and reselling of items by greatly reducing the costs of shipping and lag time associated with items that are constantly being shipped through reselling and/or trades. Furthermore, buyers are able to more quickly put funds from an expected future resale to immediate work without waiting days or months for an item to sit as listed on a third-party marketplace.

Any or all of the functions described herein may be executed by a controller or processor, such as microprocessor, executing non-transitory computer readable and executable instructions that are stored in, and retrieved from, physical data storage medium or media, which may be, for example, electronic, magnetic, or optical storage media. The retrieval and execution of such non-transitory computer readable and executable instructions by a controller or processor, such as a microprocessor, or other electronic components or circuits, may be utilized to carry out any or all of the functions of the system of the invention as described herein.

Although the above description may contain specific details, they should not be construed as limiting the claims in any way. Other configurations of the described embodiments of the disclosed systems and methods are part of the scope of this disclosure. Any of the described steps, features and/or elements of the invention may be present in the various embodiments of the invention, in any number and/or order. It is not necessary that each and every embodiment of the invention include each and every step, feature and/or element described herein.

It will be appreciated that various of the above-disclosed and other features and functions, or alternatives thereof, may be desirably combined into many other different systems or applications. Also, various alternatives, modifications, variations or improvements therein may be subsequently made by those skilled in the art which are also intended to be encompassed by the following claims.

What is claimed is:

1. A method for performing a peer-to-peer reselling of a purchased item through a livestream marketplace, the method comprising the steps of:
initiating, by a seller, a first video livestream, wherein said first video livestream is initiated by the seller generating said first video livestream and communicating said first video livestream to a hosting platform;
accessing and displaying, by a plurality of potential buyers, the first video livestream, each potential buyer of said plurality of potential buyers using a client device that is in data communication with said hosting platform to access and display the first video livestream;
offering, by the seller, to sell a first item, by displaying the first item as being for sale for a first purchase price in the first video livestream;
sending to the seller, by a first buyer, a request indicating first potential buyer's desire to purchase the first item, wherein the first buyer is one of the potential buyers comprising the plurality of potential buyers;
purchasing the first item, by the first buyer, by transferring funds in the amount of the first purchase price to the hosting platform;
sending to the hosting platform, by the first buyer, an indication of the first buyer's desire to resell the first item for a second price;
notifying the remaining potential buyers of the plurality of potential buyers, by the hosting platform, that the first item is available for purchase from the first buyer, wherein the remaining potential buyers are defined as all the potential buyers comprising the plurality of potential buyers that are not the first buyer;
sending to the first buyer, by a second buyer, a request indicating second buyer's desire to buy the first item for the second purchase price, wherein the second buyer is one of the remaining potential buyers;
purchasing the first item, by the second buyer, by transferring funds in the amount of the second purchase price to the hosting platform;
notifying the seller, by the hosting platform, that the second buyer has purchased the first item;
delivering, by the seller, the first item to the second buyer.

2. The method of claim 1, wherein the first item is one or more gaming or sports cards.

3. The method of claim 2, in which the first item is contained within a package that prevents the description of the first item from being known to the plurality of potential buyers prior to the purchase of the first item by the first buyer.

4. The method of claim 3, further comprising the step of revealing the description of the first item to the remaining potential buyers after the purchase of the first item by the first buyer.

5. The method of claim 4, in which the step of revealing the description of the first item to the remaining potential buyers is performed by the unpackaging of the first item on the first video livestream.

6. The method of claim 1, wherein the first item is one or more baseball cards.

7. The method of claim 1, further including the step of calculating shipping costs for shipping the first item from the seller to the second buyer, and adding said shipping costs to the second purchase price prior to payment of the second purchase price to the hosting platform by the second buyer.

8. The method of claim 1, further including the steps of calculating sales tax due for sale of the first item from the seller to the first buyer, and paying, by the first buyer, the sales tax due for sale of the first item to the hosting platform.

9. The method of claim 1, further including the steps of calculating sales tax due for sale of the first item from the first buyer to the second buyer, and paying, by the second buyer, the sales tax due for sale of the first item to the hosting platform.

10. The method of claim 1, in which each potential buyer of the plurality of potential buyers deposits funds into at least one potential buyer-specific account held by the hosting platform, or controlled by the hosting platform, for the purpose of receiving, holding, and paying out funds for the purchase of the item, each potential buyer having at least one unique account.

11. The method of claim 1, further including the step of withholding from the payment of the first purchase price by the first buyer, a transaction fee to be split between the hosting platform and the seller.

12. The method of claim 1, further including the step of withholding from the payment of the second purchase price by the second buyer, a transaction fee to be split between the hosting platform and the seller.

13. The method of claim 1, in which the steps of payment of the first purchase price and the second purchase price are carried out by transfer of funds in and/or out of the buyer accounts.

14. The method of claim 1, in which the steps of payment of the shipping costs is carried out by transfer of funds in and/or out of the buyer accounts.

15. The method of claim 7, in which the steps of payment of the first purchase price and the second purchase price are carried out by transfer of funds in and/or out of the buyer accounts for the first buyer and the second buyer.

16. The method of claim 8, in which the steps of payment of sales tax is carried out by transfer of funds out of the buyer account for the first buyer.

17. The method of claim 9, in which the steps of payment of sales tax is carried out by transfer of funds in and/or out of the buyer accounts for the first buyer and the second buyer.

18. The method of claim 1, in which the first video livestream is encrypted.
